(19) United States
(12) Patent Application Publication
(10) Pub. No.: US 2009/0021965 A1
(43) Pub. Date: Jan. 22, 2009

(54) ELECTRONIC DEVICE CAPABLE OF SUPPLYING POWER BI-DIRECTIONALLY THROUGH PORT AND METHOD OF OPERATING THE SAME

(75) Inventors: Young-jae KIM, Seoul (KR); Hye-jung Cho, Angyang-si (KR); Dong-rak Kim, Suwon-si (KR); Jae-deok Cha, Yongin-si (KR)

Correspondence Address: STEIN, MCEWEN & BUI, LLP, 1400 EYE STREET, NW, SUITE 300, WASHINGTON, DC, 20005, US

(73) Assignee: Samsung SDI Co., Ltd., Suwon-si (KR)

(21) Appl. No.: 12/169,846

(22) Filed: Jul. 9, 2008

(30) Foreign Application Priority Data
Jul. 20, 2007 (KR) 2007-73113

(51) Int. Cl. H02M 1/00

(52) U.S. Cl. 363/49

(57) ABSTRACT

An electronic device having a main body with a system load and capable of supplying power bi-directionally through a port, and an operation method thereof, the electronic device including: a power control apparatus to recognize a connection of an external power source for supplying power to the system load, and to control a startup of the external power source and a distribution of the power supplied from the external power source.

### CROSS-REFERENCE TO RELATED APPLICATION

This application claims the benefit of Korean Patent Application No. 2007-73113, filed Jul. 20, 2007, in the Korean Intellectual Property Office, the disclosure of which is incorporated herein by reference.

### BACKGROUND OF THE INVENTION

1. Field of the Invention

Aspects of the present invention relate to an electronic device and an operating method thereof, and more particularly, to an electronic device capable of supplying power bi-directionally through a port and an operating method thereof.

2. Description of the Related Art

In general, a conventional portable electronic device (such as a notebook computer, a portable phone, a digital camera, a camcorder, a personal digital assistant (PDA), and a global positioning system (GPS)) includes a power unit. The power unit includes a battery, a battery charger to charge the battery using external power, an adapter port to receive the external power, a direct-current/direct-current (DC-DC) converter to supply appropriate power to a system load, and a controller to control a charge and a discharge of the battery and a supply of power to the DC-DC converter.

Due to limitations in terms of circuit configuration, the power unit of the conventional electronic device can only receive external power. That is, the power unit cannot supply power from the battery to an outside of the conventional electronic device. For this reason, the conventional electronic device may include only a limited range of power sources.

For example, a currently introduced advanced power supply system (for example, a fuel cell system) receives startup power from an external source. However, since the conventional electronic device cannot externally supply power as described above, the advanced power supply system cannot be used as a power source of the conventional electronic device.

### SUMMARY OF THE INVENTION

Aspects of the present invention provide an electronic device capable of supplying and/or receiving power through a port, and an operation method thereof.

According to an aspect of the present invention, there is provided an electronic device including a main body with a system load, the electronic device including: a power control apparatus to recognize a connection of an external power source for supplying power to the system load, and to control a startup of the external power source and a distribution of the power supplied from the external power source.

The power control apparatus may include: a power detection unit to detect the connection of the external power source with the main body, and to generate a connection signal when the connection of the external power source with the main body is detected; a startup power application unit to supply a startup power to the external power source for the startup of the external power source; and a driving power controller to control the distribution of the power supplied from the external power source.

The power detection unit may be a port to mount the external power source onto the main body.

The port may be an adapter port including a channel that detects the connection of the external power source with the main body and generates the connection signal when the connection of the external power source with the main body is detected.

The startup power application unit may be a battery or a battery pack that supplies power to the system load according to a control of the driving power controller.

The startup power application unit may be connected to the main body through a port or may be embedded in the main body.

The electronic device may further include a switch unit and a direct-current/direct-current (DC-DC) converter between the startup power application unit and the system load.

The switch unit may control a charge and a discharge of the startup power application unit.

The DC-DC converter may convert power supplied from the startup power application unit and/or the external power source to power required for the system load.

The switch unit may further include a charger to charge the startup power application unit.

The driving power controller may be a control unit to control power supplied from the startup power application unit to the system load.

The external power source may be a fuel cell system.

According to another aspect of the present invention, there is provided a method of operating an electronic device including a main body with a system load, the method including: recognizing a connection of an external power source, for supplying power to the system load, with the main body; and supplying a startup power to the external power source when the connection is recognized.

The supply of the startup power may include enabling a switch connected to the external power source.

The method may further include determining if a predetermined amount of power is supplied from the external power source.

If it is determined that the predetermined amount of power is supplied, the supply of power from a startup power application unit, which supplies the startup power to the external power source, to the system load may be cut off.

If it is determined that the predetermined amount of power is not supplied, the system load may be driven with only power supplied from the startup power application unit.

The recognizing of the connection of the external power source with the main body may include: generating a connection signal from a portion of the external power source that is connected with the main body; and recognizing the generated connection signal.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become more apparent and more readily appreciated from the following description of the embodiments, taken in conjunction with the accompanying drawings of which:

FIG. 1 is a block diagram of an electronic device according to an embodiment of the present invention;

FIG. 2 illustrates a port included in the electronic device shown in FIG. 1; and

FIG. 3 is a flowchart illustrating a method of operating the electronic device according to an embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between”, “adjacent” versus “directly adjacent”, etc.).

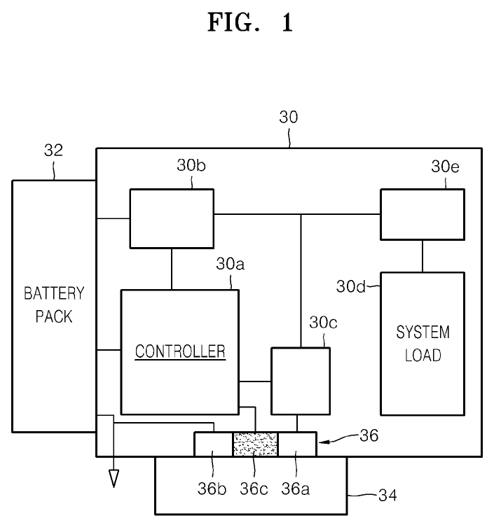

An electronic device capable of supplying power bi-directionally through a port according to aspects of the present invention will now be described with reference to FIG. 1. FIG. 1 is a block diagram of an electronic device according to an embodiment of the present invention.

Referring to FIG. 1, the electronic device includes a main body 30, a battery pack 32, an external power source 34, and a port 36. The battery pack includes a battery and a battery control circuit. The main body 30 includes a controller 30a, a first switch unit 30b, a second switch unit 30c, a direct-current/direct-current (DC-DC) converter 30e, and a system load 30d. The controller 30a detects if the external power source 34 is connected to the main body 30, and determines if power (such as startup power) is to be supplied to the external power source 34. For example, the controller 30a may determine that power is to be supplied according to a type or a characteristic of the external power source 34. The controller 30a also controls power supplied to the DC-DC converter 30e. In particular, the controller 30a controls the first and second switch units 30b and 30c, and divides power supplied from the battery pack 32 and power supplied from the external power source 34. In other words, the controller 30a determines which one of the power from the battery pack 32, the power from the external power source 34, and power from another source is to be supplied to the DC-DC converter 30e. Therefore, the controller 30a may also function as a driving power controller that controls a distribution of power supplied from the external power source 34.

The external power source 34 may be an arbitrary adapter or a unit with an independent power source. In the latter case, the external power source 34 may be, for example, a fuel cell system, a bio-cell, or a solar battery. The external power source 34 is mounted on the main body 30 via the port 36. The port 36 includes first through third channels 36a, 36b, and 36c. The first and second channels 36a and 36b function to supply power bi-directionally, and the third channel 36c functions to recognize the mounting of the external power source 34 onto the main body 30 and to generate a recognition signal accordingly. In this case, the first channel 36a may supply positive power bi-directionally, while the second channel 36b may supply negative power bi-directionally. Supplying power bi-directionally, when the external power source 34 is the unit with the independent power source, refers to supplying power from the main body 30 to the external power source 34 and/or from the external power source 34 to the main body 30. Therefore, when the external power source 34 is the ordinary adapter, only two channels 36a and 36b may be used and the third channel 36c may not be used. However, it is understood that aspects of the present invention are not limited to this configuration. For example, the first and third channels 36a and 36c may function to supply power bi-directionally, while the second channel 36b functions to recognize the mounting of the external power source 34. Furthermore, the second channel 36b may supply positive power bi-directionally, while the first channel 36a may supply negative power bi-directionally.

As described above, the port 36 may be the same as an ordinary adapter port to which a new channel for generating a recognition signal is added. The port 36 may also serve as an external power detector because when the external power source 34 has an independent power source, the port 36 detects the mounting of the external power source 34 (i.e., the connection of the external power source 34 onto/with the main body 30), and transmits a connection signal to the controller 30a once the detection has been made.

A connection signal output from any one channel (e.g., the third channel 36c) of the port 36 is transmitted to the controller 30a. Accordingly, the controller 30a controls at least one of the first switch unit 30b and the second switch unit 30c in response to the connection signal from the port 36.

For example, a switch control unit (not shown) of the controller 30a enables the second switch unit 30c in response to the connection signal. As a result, power may be supplied from the battery pack 32 through the second switch unit 30c and the port 36 to the external power source 34 of the main body 30. Therefore, when the external power source 34 is a unit requiring power (for example, startup power), the external power source 34 receives the startup power from the battery pack 32 in response to the connection signal. As described above, the battery pack 32 may function as a startup application unit to apply startup power to the external power source 34.

Considering that the port 36 functions as a power detection unit, the battery pack 32 functions as a startup power application unit, and the controller 30a functions as a driving power controller, the port 36, the battery pack 32, and the controller 30a may be considered to be an external power control apparatus that controls the mounting and driving of the external power source 34, and distribution of power generated by the external power source 34.

The first switch unit 30b controls a charge and a discharge of the battery pack 32 according to a control of the controller 30a. The first switch unit 30b may include at least one switch. Although not shown in the drawings, the first switch unit 30b may further include a battery charger and a switch to control a charge of the battery of the battery pack 32. In this case, the switch to control the charge of the battery of the battery pack 32 may be a high-voltage field effect transistor (FET), and may further include a diode that is installed parallel to the high-voltage FET. The second switch unit 30c may control power supplied from the external power source 34 to the main body 30, and power supplied from the battery pack 32 to the external power source 34 according to a control of the controller 30a. As described above, when the connection signal is applied from the external power source 34 to the controller 30a, the controller 30a maintains the second switch unit 30c in an enabled state. When the external power source 34 is separated from the main body 30, the controller 30a maintains the second switch unit 30c in a disabled state in order to prevent power from the battery pack 32 from being externally supplied through the port 36. The second switch 30c may include at least one switch (such as a high-voltage FET), and may further include a diode that is installed parallel to the at least one switch.

An electronic device according to aspects of the present invention may be, for example, a notebook computer, a digital camera, a global positioning system (GPS), a personal digital assistant (PDA), a camcorder, a portable phone, or a portable display device.

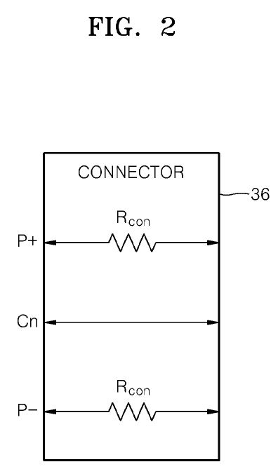

FIG. 2 illustrates an example of the port 36 included in the electronic device shown in FIG. 1. Referring to FIG. 2, a channel P+ supplies positive power to and from the main body 30 (i.e., bi-directionally), while a channel P− supplies negative power bi-directionally. Also, a channel Cn detects a connection of the external power source 34 with the main body 30, and generates a connection signal to indicate a connection between the external power source 34 and the main body 30.

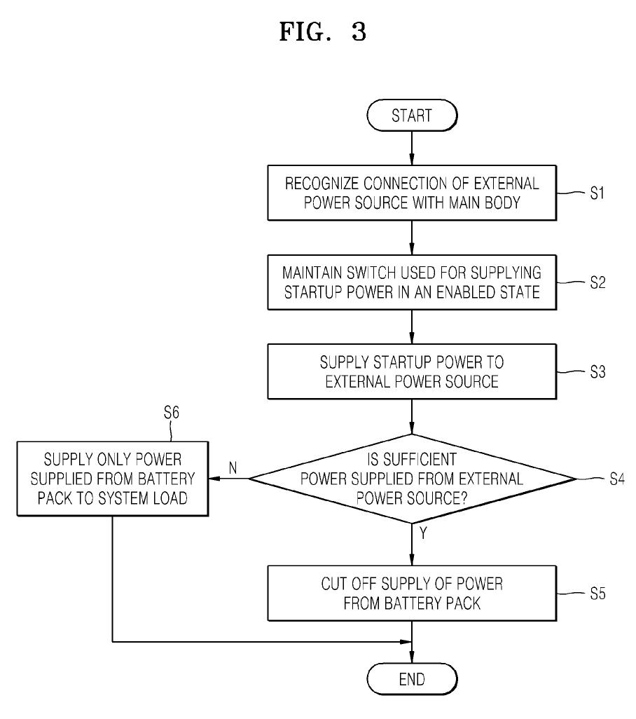

Hereinafter, a method of operating an electronic device using the external power source 34 will be described with reference to FIG. 3. FIG. 3 is a flowchart illustrating a method of operating the electronic device according to an embodiment of the present invention.

Referring to FIGS. 1 and 3, a connection of the external power source 34 to the electronic device is recognized in operation S1. Specifically, if the external power source 34 is connected to the port 36, a portion of the external power source 34 contacts the third channel 36c (though it is understood aspects of the present invention are not limited thereto, and the portion of the external power source 34 may contact another channel 36a and 36b). In this case, the portion of the external power source 34 may be a terminal with a predetermined length (such as an adapter terminal) or a contact surface. When the portion is a terminal, the third channel 36c may be a hole-type channel. In contrast, if the portion is a contact surface, the third channel 36c may also be a contact surface. Furthermore, when the portion of the external power source 34 contacts the third channel 36c, an electrical or magnetic reaction is caused in the third channel 36c due to a contact state. As the result of the reaction, a contact signal or connection signal Cn is applied from the third channel 36c to the controller 30a. In response to the connection signal Cn, the controller 30a recognizes that the external power source 34 connected to the port 36 is not an ordinary adapter, but a power source requiring startup power. However, it is understood that aspects of the present invention are not limited thereto, and other methods may be used to recognize that the external power source 34 requires power.

In operation S2, a switch is enabled in order to supply startup power to the external power source 34. Specifically, the controller 30a simultaneously recognizes the connection of the external power source 34 and enables the second switch unit 30c that is connected to the external power source 34.

In operation S3, the startup power is supplied to the external power source 34. Specifically, the first switch unit 30b, which controls a charge and a discharge of the battery pack 32, remains enabled such that power supplied from the battery pack 32 is directly supplied to the DC-DC converter 30e when the battery pack 32 is mounted onto the main body 30. However, the first switch unit 30b may also be disabled when power is not supplied from the battery pack 32 to the system load 30d. Therefore, when the second switch unit 30c is enabled in operation S2, power is supplied from the battery pack 32 to the external power source 34 through the first and second switch units 30b and 30c and the port 36 in order to start the external power source 34.

In operation S4, it is determined if sufficient power is generated by the external power source 34. Specifically, after the startup power is supplied from the battery pack 32 to the external power source 34, the external power source 34 starts generating power. In this case, if the power generated by the external power source 34 reaches a level required by the system load 30d (operation S4-Y), the supply of power is cut off from the battery pack 32 to the DC-DC converter 30e in operation S5. Specifically, the first switch unit 30b is disabled in response to a switch control signal output from the controller 30a so as to cut off the supply of power from the battery pack 32 to the DC-DC converter 30e.

Otherwise, if power generated by the external power source 34 does not reach a level required by the system load 30d (S4-N), only power from the battery pack 32 is supplied to the system load 30d in operation S6.

According to aspects of the present invention as described above, power can be supplied bi-directionally through a port included in an electronic device, so that the electronic device can also function as a power source. Therefore, an external power source that uses startup power can also be used as a power source for the electronic device, thus expanding the versatility of the electronic device.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An electronic device including a main body with a system load, the electronic device comprising:
a power control apparatus to recognize a connection of an external power source for supplying power to the system load, and to control a startup of the external power source and a distribution of the power supplied from the external power source.

2. The electronic device as claimed in claim 1, wherein the power control apparatus comprises:
a power detection unit to detect the connection of the external power source with the main body, and to generate a connection signal when the connection of the external power source with the main body is detected;
a startup power application unit to supply a startup power to the external power source for the startup of the external power source; and
a driving power controller to control the distribution of the power supplied from the external power source.

3. The electronic device as claimed in claim 2, wherein the power detection unit is a port to mount the external power source onto the main body.

4. The electronic device as claimed in claim 3, wherein the port is an adapter port including a channel that detects the connection of the external power source with the main body, and generates the connection signal when the connection of the external power source with the main body is detected.

5. The electronic device as claimed in claim 2, wherein the startup power application unit is a battery or a battery pack that supplies power to the system load according to a control of the driving power controller.

6. The electronic device as claimed in claim 2, wherein the startup power application unit is connected to the main body through a port.

7. The electronic device as claimed in claim 6, further comprising:
a switch unit to control a charge and a discharge of the startup power application unit; and
a direct-current/direct-current (DC-DC) converter to convert power supplied from the startup power application unit and/or the external power source to power for the system load.

8. The electronic device as claimed in claim 7, wherein the switch unit further comprises a charger to charge the startup power application unit.

9. The electronic device as claimed in claim 2, wherein the driving power controller controls power supplied from the startup power application unit to the system load.

10. The electronic device as claimed in claim 1, wherein the external power source is a fuel cell system.

11. The electronic device as claimed in claim 2, further comprising:
a switch unit to control a charge and a discharge of the startup power application unit; and
a DC-DC converter to convert power supplied from the startup power application unit and/or the external power source to power for the system load.

12. A method of operating an electronic device including a main body with a system load, the method comprising:
recognizing a connection of an external power source, for supplying power to the system load, with the main body; and
supplying a startup power to the external power source when the connection is recognized.

13. The method as claimed in claim 12, wherein the supplying of the startup power comprises manipulating a switch connected to the external power source.

14. The method as claimed in claim 12, further comprising determining if a predetermined amount of power is supplied from the external power source.

15. The method as claimed in claim 14, wherein if the predetermined amount of power is supplied from the external power source, a supplying of power from a startup power application unit, which supplies the startup power to the external power source, to the system load is cut off.

16. The method as claimed in claim 14, wherein if the predetermined amount of power is not supplied from the external power source, the system load is driven only with power supplied from a startup power application unit, which supplies the startup power to the external power source.

17. The method as claimed in claim 12, wherein the recognizing of the connection of the external power source with the main body comprises:
generating a connection signal from a portion of the main body to which the external power source is connected; and
recognizing the generated connection signal.

18. The method as claimed in claim 17, wherein the supplying of the startup power comprises:
supplying the startup power to the external power source, from a startup power application unit, when the generated connection signal is recognized.

19. The method as claimed in claim 18, wherein a port that mounts the external power source onto the main body detects the connection of the external power source.

20. The method as claimed in claim 19, wherein the port is an adapter port including a channel that detects the connection of the external power source with the main body, and generates the connection signal.

21. The method as claimed in claim 18, wherein the startup power application unit is a battery or a battery pack that supplies power to the system load.

22. The method as claimed in claim 21, further comprising:
controlling a charge and a discharge of the startup power application unit; and
converting power supplied from the startup power application unit and/or the external power source to power for the system load.

23. The method as claimed in claim 18, further comprising controlling a distribution of power supplied from the startup power application unit to the system load.

24. The method as claimed in claim 18, after the supplying the startup power to the external power source is performed, controlling a distribution of power supplied from the external power source is further performed.
